(19) United States
(12) Patent Application Publication
(10) Pub. No.: US 2025/0335820 A1
(43) Pub. Date: Oct. 30, 2025

(54) REINFORCEMENT LEARNING METHOD APPLYING TODDLER-INSPIRED SEQUENTIAL REWARD TRANSITION, AND REINFORCEMENT LEARNING APPARATUS PERFORMING THE SAME

(71) Applicant: SEOUL NATIONAL UNIVERSITY R&DB FOUNDATION, Seoul (KR)

(72) Inventors: Byoung-Tak ZHANG, Seoul (KR); Junseok PARK, Seoul (KR); Hee Bin YOO, Seoul (KR); Won-Seok CHOI, Seoul (KR); Kibeom KIM, Suwon-si (KR); Min Whoo LEE, Seoul (KR); Minsu LEE, Seoul (KR)

(21) Appl. No.: 18/780,911

(22) Filed: Jul. 23, 2024

(30) Foreign Application Priority Data
Apr. 25, 2024 (KR) 10-2024-0055610

(51) Int. Cl. G06N 20/00

(52) U.S. Cl. CPC G06N 20/00

(57) ABSTRACT

The embodiments disclosed herein provide a reinforcement learning method and apparatus. The reinforcement learning method is performed by the reinforcement learning apparatus. A reinforcement learning method according to an embodiment comprises: obtaining information about an agent, which is trained by reinforcement learning; and performing the reinforcement learning of the agent based on first reward, and, after a predetermined point, transitioning reward to second reward having a density different from that of the first reward and then performing the reinforcement learning of the agent.

### CROSS-REFERENCE TO RELATED APPLICATION

This application claims the benefit of Korean Patent Application No. 10-2024-0055610 filed on Apr. 25, 2024, which is hereby incorporated by reference herein in its entirety.

### BACKGROUND

### 1. Technical Field

The embodiments disclosed herein relate to a reinforcement learning method to which sequential reward transition is applied and a reinforcement learning which performs the reinforcement learning method. More specifically, the embodiments disclosed herein relate to a reinforcement learning method to which toddler-inspired sequential reward transition is applied and a reinforcement learning which performs the reinforcement learning method.

At least some of the embodiments disclosed herein were derived as a result of the research on the task “Goal-oriented Self-supervised Reinforcement Learning for Real-world Applications” (Task management number: NRF-2021R1A2C1010970) of the Individual Basic Research Project that was sponsored by the Korean Ministry of Science and ICT and the National Research Foundation of Korea.

At least some of the embodiments disclosed herein were derived as a result of the research on the task “Development of Uncertainty-Aware Agents Learning by Asking Questions” (Task management number: IITP-2022-0-00951) and task “Self-directed AI Agents with Problem-solving Capability” (Task management number: IITP-2022-0-00953) of the Human-centered Artificial Intelligence Fundamental Technology Development Project that was sponsored by the Korean Ministry of Science and ICT and the Institute of Information & Communications Technology Planning & Evaluation.

At least some of the embodiments disclosed herein were derived as a result of the research on the task “Artificial Intelligence Institute” (Task management number: NRF-00274280) of the Science and Engineering Academic Research Infrastructure Construction Project that was sponsored by the Korean Ministry of Science and ICT and the National Research Foundation of Korea.

At least some of the embodiments disclosed herein were derived as a result of the research on the task “Artificial Intelligence Innovation Hub” (Task management number: IITP-2021-0-02068) of the Information, Communications and Broadcasting Innovative Talent Nurturing Project that was sponsored by the Korean Ministry of Science and ICT and the Institute of Information & Communications Technology Planning & Evaluation.

### 2. Description of the Related Art

Reinforcement learning (RL) is an area of machine learning, and refers to a learning method by which learning is performed in such a manner that an agent defined within a specific environment recognizes a current state and selects an action or action sequence that maximizes reward from selectable actions.

In reinforcement learning, it is important to strike an appropriate balance between exploitation and exploration in order to an agent to select an action that can maximize reward. In this case, the exploitation means performing an action that can obtain the greatest reward in a current state, and the exploration means a new attempt to accumulate various experiences. In order to obtain rich experiences, there is a risk of having to give up what is currently the best action, so that the key to reinforcement learning is to strike an appropriate balance between exploitation and exploration. For this purpose, it is important to optimize a reward system.

In connection with this, research has been conducted to optimize reward for the goal of learning, as in Korean Patent No. 10-2195433. However, this is merely intended to optimize reward at an exploitation stage in a specific field. Therefore, a problem arises in that it is difficult to obtain the generalization ability to apply an agent to various application fields.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

An object of the embodiments disclosed herein is to propose a reinforcement learning method that performs reinforcement learning based on sparse reward, transitions the reward to be provided to dense reward after a predetermined point, and then performs reinforcement learning and also propose a reinforcement learning apparatus that performs the reinforcement learning method.

An object of the embodiments disclosed herein is to propose a curriculum learning-based reinforcement learning method that transitions reward from sparse reward to dense reward and a reinforcement learning apparatus that performs the curriculum learning-based reinforcement learning method.

According to an aspect of the present invention, there is provided a reinforcement learning method, the reinforcement learning method being performed by a reinforcement learning apparatus, the reinforcement learning method comprising: obtaining information about an agent, which is trained by reinforcement learning; and performing the reinforcement learning of the agent based on first reward, and, after a predetermined point, transitioning reward to second reward having a density different from that of the first reward and then performing the reinforcement learning of the agent.

According to another aspect of the present invention, there is provided a reinforcement learning apparatus, comprising: memory configured to store programs required for the generation of an agent and reinforcement learning; and a controller configured to obtain information about the agent, which is trained by reinforcement learning, and to perform the reinforcement learning of the agent based on first reward, and, after a predetermined point, transitioning reward to second reward having a density different from that of the first reward and then performing the reinforcement learning of the agent.

According to still another aspect of the present invention, there is provided a computer program that is executed by a reinforcement learning apparatus and stored in a non-transitory computer-readable storage medium to perform a reinforcement method. The reinforcement learning method comprises: obtaining information about an agent, which is trained by reinforcement learning; and performing the reinforcement learning of the agent based on first reward, and, after a predetermined point, transitioning reward to second reward having a density different from that of the first reward and then performing the reinforcement learning of the agent.

According to still another aspect of the present invention, there is provided a non-transitory computer-readable storage medium having stored thereon a program that, when executed by a processor, causes the processor to execute a reinforcement method. The reinforcement learning method comprises: obtaining information about an agent, which is trained by reinforcement learning; and performing the reinforcement learning of the agent based on first reward, and, after a predetermined point, transitioning reward to second reward having a density different from that of the first reward and then performing the reinforcement learning of the agent.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram schematically illustrating a reinforcement learning method according to an embodiment;

FIG. 2 is a block diagram showing the configuration of a reinforcement learning apparatus according to an embodiment;

FIG. 3 is a diagram illustrating an example of the curriculum of reinforcement learning according to an embodiment;

FIG. 4 is a diagram illustrating the types of reward according to an embodiment;

FIG. 5 is a diagram illustrating the performance of a reinforcement learning method according to an embodiment; and

FIGS. 6 and 7 are flowcharts illustrating a reinforcement learning method according to an embodiment.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the accompanying drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component arranged therebetween.” Furthermore, when one portion is described as “including” one component, this does not mean that the portion does not exclude another component but means that the portion may further include another component, unless explicitly described to the contrary.

Embodiments will be described in detail below with reference to the accompanying drawings.

However, prior to the following description, the meanings of the terms to be used below are first defined.

The term “agent” refers to a system that has a state and can interact with an environment or other agents. There are a software agent that functions in a computer network or program world and a hardware agent that has substance and can operate in the real world.

The agent in the present specification is a program that performs automated actions, and is a goal-based agent that collects and analyzes information in a given environment and selects actions to achieve a goal. To this end, the agent can recognize the state of the given environment, perform optimal actions according to an algorithm for determining actions, i.e., policy, and receive reward according to the actions. In this case, the desired goal is considered to be achieved by maximizing the cumulative reward accumulated until the end of selection of actions. Meanwhile, the agent may be an artificial intelligence-based agent, and artificial neural network or deep learning technology may be applied.

The term “sparse” means that an area narrower than an overall state space is supported by a reward function for a specific activity. In other words, it may mean that the area where reward is given out of an overall environmental space is narrow, and the reward in this case may be called “sparse reward.” For example, sparse reward is the reward given only when the agent reaches a goal. As an example, it may be the reward given when the agent reaches a distance from a target object within a threshold.

In contrast, the term “high-density” or “dense” means that a relatively large area is supported by a reward function for a specific activity than in the case of sparse reward, and the reward in this case may be called dense reward. For example, dense reward may have a wider reward zone than sparse reward. In the case of dense reward, reward may be provided when the goal has been reached, as in the case of sparse reward, and also reward may be provided depending on the proximity to the goal.

The terms requiring descriptions other than those defined above will be described separately below.

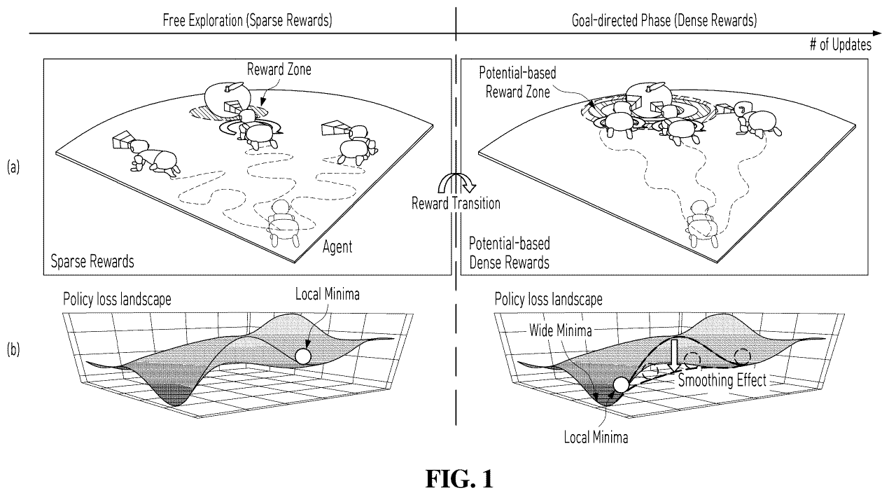

FIG. 1 is a diagram illustrating the schematic concept of a reinforcement learning method according to an embodiment. More specifically, FIG. 1(a) shows the reinforcement learning of the agent inspired the behavioral characteristics of toddlers in their toddler step, and FIG. 1(b) shows policy loss landscapes for respective learning steps. The horizontal axis of FIG. 1 represents the cumulative number of updates (# of Updates).

The reinforcement learning method according to an embodiment is a reinforcement learning method that is inspired by the reward transition of toddlers in their toddler step and applies the reward transition to a learning step after a predetermined point. Without expecting immediate reward, toddlers interact with their surroundings without prior knowledge, then transition to goal-directed learning aimed at specific goals. In other words, as shown on the left of FIG. 1(a), toddlers freely explore without expecting immediate reward when they start new experiences. As they grow, they can transition to goal-directed learning, where they focus on a specific goal such as an apple, as shown on the right of FIG. 1(a), and engage in behavior that strives for known reward for their effort.

This learning pattern of toddlers may be incorporated into reinforcement learning (RL). In reinforcement learning, an agent may correspond to the toddler in FIG. 1(a) and may learn by interacting with an environment and receiving feedback in the same manner as the toddler learns through interaction. More specifically, like the toddler, the agent may be trained in the direction in which positive feedback is given sparsely or densely, i.e., in the direction in which reward is provided. In this case, sparse feedback might mean that the agent requires more attempts to figure out the desired behavior due to limited guidelines (Andrychowicz et al. 2020; Knox et al. 2023). Meanwhile, dense feedback can guide the agent faster but might inadvertently focus on immediate outcomes, missing out on the bigger picture or long-term strategies (Laud 2004).

To this end, in the reinforcement learning method according to an embodiment, an agent may first learn in a free exploration stage (sparse reward) where sparse reward is provided, and may then, after a predetermined point, perform reward transition to a goal-directed stage (dense reward) where potential-based dense reward is provided. In other words, the reinforcement learning apparatus may perform curriculum learning in which the density of reward varies with the stage in such a manner that an agent first performs reinforcement learning in an exploration stage where sparse reward is provided and then transitions to a goal-oriented stage where dense reward is provided, as described above, according to a general-specific approach in which an agent initially collects various learning experiences and then later exploits these experiences in a curriculum.

Meanwhile, the effect of the reinforcement learning method according to an embodiment may be determined by observing changes in the policy loss landscape according to the reward transition, as shown in FIG. 1(b). The altitude of the loss landscape may represent the loss for a specific parameter (Li et al. 2018). The goal of reinforcement learning may be to find the minima that minimize the loss. In this case, the wide minima have a wide slope, so that gradient descent is likely to converge smoothly to the global minima, which may mean that the agent can have robustness and excellent generalization for new data (Keskar et al. 2016). Conversely, in sharp minima, steep gradients can trap agents in local minima, resulting in overfitting and poor generalization across diverse data distributions (Goodfellow, Vinyals, and Saxe 2014). In other words, artificial intelligence models within wide minima demonstrate better performance and generalization than those in sharp minima (Keskar et al. 2017; Jastrzebski et al. 2018). In deep RL as well, where the distribution of agent's experiences may slightly vary every time step, policies in wide minima could improve in generalization.

More specifically, referring to FIG. 1(b), the policy loss landscape of the goal-oriented stage on the right may lead to wide minima via a smoothing effect in which the depth of local minima is reduced and the loss slope becomes smoother, compared to the policy loss landscape of the exploration stage on the left. This means that generalization is further improved. The reinforcement learning method according to an embodiment performs learning from an exploration stage in which sparse reward is provided to a goal-oriented stage in which the density of reward is increased, so that the generalization performance of the agent can be improved, thereby increasing adaptability to problems in various fields.

The reinforcement learning apparatus 100 described above may be implemented as an electronic terminal, a server, or a server-client system.

In this case, the electronic terminal may be implemented as a computer, a mobile terminal, a television, a wearable device, or the like that can access a remote server or connect with another electronic terminal and a server over a network. In this case, the computer includes, e.g., a notebook, a desktop, a laptop, and the like each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like. Furthermore, the television may include an Internet Protocol Television (IPTV), an Internet Television (Internet TV), a terrestrial TV, a cable TV, and the like. Furthermore, the wearable device is an information processing device of a type that can be directly worn on a human body, such as a watch, glasses, an accessory, clothing, shoes, or the like, and can access a remote server or connect with another terminal directly or via another information processing device over a network. Moreover, the server may be implemented as a computing device capable of communicating with an electronic terminal over a network or may be implemented as a cloud computing server.

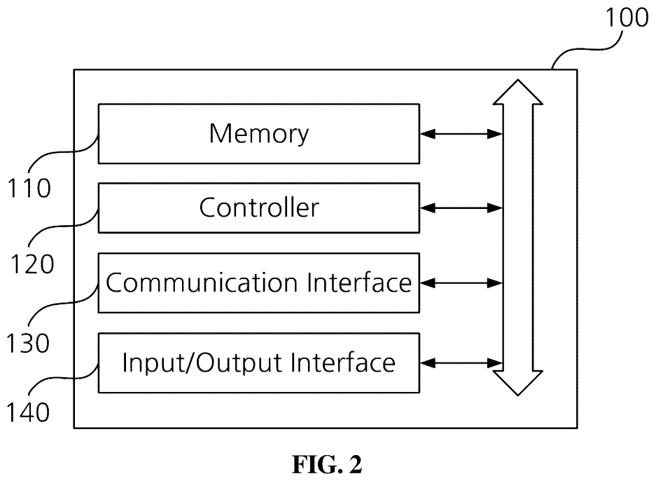

FIG. 2 is a block diagram showing a reinforcement learning apparatus 100 according to an embodiment.

Referring to FIG. 2, the reinforcement learning apparatus 100 according to an embodiment may include memory 110, a controller 120, a communication interface 130, and an input/output interface 140.

The memory 110 may be constructed using various types of memory. A program for generating an agent that is trained by the reinforcement learning and a program and data for performing reinforcement learning method may be installed and stored in the memory 110. A program for performing reinforcement learning, and data required for reinforcement learning, such as data defining an environment and parameters, may be installed and stored in the memory 110.

In particular, the memory 110 may store data and a program that enable the controller 120, which will be described later, to perform a reinforcement learning method according to a process to be presented below.

The controller 120 is a component including at least one processor such as a central processing unit (CPU), a graphics processing unit (GPU) and performs the reinforcement learning method to be presented below by executing the program stored in the memory 110. Furthermore, the controller 120 may control other components included in the reinforcement learning apparatus 100 to perform operations corresponding to inputs received through the input/output interface 140. For example, the controller 120 may read a file stored in the memory 110 or store a new file in the memory 110. Furthermore, the controller 120 may execute the program stored in the memory 110 to generate an artificial intelligence model, i.e., an agent, which is trained by the reinforcement learning, and to perform the reinforcement learning of the agent. A process in which the controller 120 performs the reinforcement learning method will be described in detail with reference to other drawings below.

Meanwhile, the communication interface 130 may perform wired/wireless communication with another device or a network. To this end, the communication interface 130 may include a communication module supporting at least one of various wired/wireless communication methods, and the communication module may be implemented in the form of a chipset. The wireless communication supported by the communication interface 130 includes, e.g., Wireless Fidelity (Wi-Fi), Wi-Fi Direct, Bluetooth, Ultra-Wide Band (UWB), or Near Field Communication (NFC).

The input/output interface 140 is configured to display information such as a reinforcement learning process or the results of reinforcement learning. For example, the input/output interface 140 may display a policy loss landscape according to reward transition, and may include an output device such as a display panel or a speaker for this purpose.

Furthermore, the input/output interface 140 is configured to receive a hyperparameter, such as a reward transition point, from a user when the reinforcement learning method is performed. To this end, the input/output interface 140 may include various types of input devices (e.g., a keyboard, a touch screen, a camera, and/or the like) to receive input from the user.

A reinforcement learning method performed by the reinforcement learning apparatus according to an embodiment in such a manner that the controller 120 executes the program stored in the memory 110 will be described in detail below. The processes to be described below are performed in such a manner that the controller 120 executes the program stored in the memory 110, unless otherwise specified.

The controller 120 may generate an agent by using the program stored in memory and perform curriculum-based reinforcement learning for the generated agent.

Reinforcement learning is an area of machine learning in which agents learn through trial and error, like in the method by which humans acquire skills, and may be applied to a variety of tasks that require sequential decision-making. Reinforcement learning may be represented by a Markov decision process (MDP), which is defined as [symbol] [symbol] , [symbol] , [symbol] , [symbol] , γ [symbol] . In this case, [symbol] is a set of environmental states, [symbol] is a set of possible actions, [symbol] is a transition probability distribution defined by [symbol] : [symbol] × [symbol] →Δ( [symbol] ), [symbol] is a reward defined by [symbol] : [symbol] × [symbol] → [symbol] , and γ is a discount factor.

In this case, at each time step t (where t∈ [symbol] ), the agent in the current state sₜ (where sₜ∈ [symbol] ) may take an action αₜ (where αₜ∈ [symbol] ) according to policy π(⋅|sₜ) and receive a subsequent state sₜ₊₁˜ [symbol] (⋅|sₜ, αₜ) and reward [symbol] (sₜ, αₜ) based on the action αₜ.

Reinforcement learning aims to find the optimal policy π* (where π*∈Π* and Π* is the set of optimal policies) that maximize the expected cumulative reward

$$R = 𝔼 [ {\sum }_{t = 0}^{∞} {γ}^{t} ℛ ( {s}_{t} , {a}_{t} ) ]$$

in the state in which the discount factor γ is applied thereto.

Meanwhile, when the learning of an agent is performed using a reinforcement learning method, the controller 120 may train the agent using curriculum learning-based reinforcement learning. Curriculum learning in the reinforcement learning method according to an embodiment will be described below.

### Curriculum Learning-Based Reinforcement Learning

Curriculum learning may train an agent while gradually increasing the level of difficulty or may train an agent by a general-to-specific approach that the agent initially collects various types of data or experiences and then exploits on these data or experiences later. The reinforcement learning method according to an embodiment may be a method of performing curriculum-based reinforcement learning that provides the reward that gradually increases in density in such a manner that learning in an exploration stage in which sparse reward is provided at first, and then performs learning in a goal-oriented stage in which dense reward is provided, as in the general-to-specific method. Curriculum-based reinforcement learning may also be defined as a series of MDPs that transition sequentially.

The curriculum [symbol] of curriculum learning-based reinforcement learning may be defined as a tuple

$$𝒞 = ( {\{ {ℳ}_{i} \}}_{i = 1}^{N} , 𝒯 ) . {\{ {ℳ}_{i} \}}_{i = 1}^{N}$$

may denote a series of Markov decision processes (MDPs), which is [symbol] ᵢ= [symbol] [symbol] , [symbol] , [symbol] , [symbol] ᵢ, γ [symbol] , and i may denote each of the learning stages that constitute curriculum learning and may satisfy i∈{1, . . . , N}. The individual Markov decision processes that constitute the series of MDPs may correspond to the respective learning stages that constitute curriculum learning. For example, in the case of a curriculum consisting of two stages, the MDP of the exploration stage in which sparse reward is provided may be [symbol] ₁, and the MDP of the goal-oriented stage in which dense reward is provided may be [symbol] ₂.

Although the stages of reinforcement learning are classified into two stages in the above-described embodiment, they are not limited thereto. The number of learning stages may vary depending on the agent to be trained, the learning environment, or the application field of the agent. For example, the stages of reinforcement learning may be divided into a first stage that provides sparse reward, a second stage that provides moderate-density reward, and a third stage that provides dense reward.

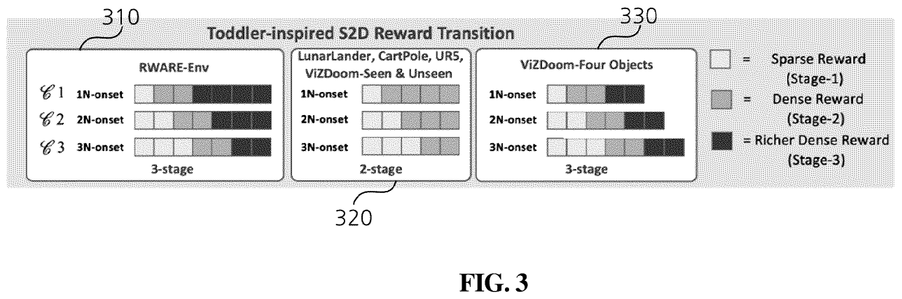

FIG. 3 is a diagram illustrating an example of the curriculum of reinforcement learning according to an embodiment. More specifically, FIG. 3 shows the setting of an experiment in which different transition points in time are used in the toddler-inspired S2D reward transition from sparse reward to dense reward in the same environment. curriculum 1 to 3 [symbol] ₁, [symbol] ₂, and [symbol] ₃ may refer to curriculum 1 having different transition points in time, respectively.

The controller 120 may transition to a learning stage having a reward density different from that of a previous learning stage after a predetermined point. In this case, the predetermined point may be a hyperparameter input by a user. For example, the hyperparameter input from the user may be the number (N) of frames or updates to be used for training in the exploration stage that provides sparse reward.

For example, as in curriculum 1 [symbol] ₁, the controller 120 may perform reinforcement learning in an exploration stage for the number (1N) of input frames or updates and may then transition to a goal-oriented stage that provides dense reward and perform reinforcement learning (1N-onset). Alternatively, the controller 120 may perform reinforcement learning in an exploration stage for twice (2N) the number (N) of input frames or updates, as in curriculum 2 [symbol] ₂, or three times (3N) the number (N) of input frames or updates, as in curriculum 3 [symbol] ₃, and may then transition to a goal-oriented stage that provides dense reward and perform reinforcement learning (2N-onset, or 3N-onset).

Meanwhile, referring to FIG. 3, the number of learning stages in the curriculum of reinforcement learning may vary depending on the environment or situation to which the curriculum is applied, such as the implementation environment in which reinforcement learning is actually implemented.

For example, as shown in FIG. 3, the controller 120 may perform reinforcement learning according to a three-stage curriculum in which reward transition is performed in the sequence of sparse reward, dense reward, and richer dense reward, as in RWAVE-Env 310 or VizDoom-Four Object 330. Alternatively, the controller 120 may perform reinforcement learning according to a two-stage curriculum in which reward transition is performed in the sequence of sparse reward and dense reward, as in LunarLander, CartPole, UR5, and VizDoom-Seen & Unseen 320.

In this case, RWAVE-Env is set such that in the grid world, the agent transports a requested one of a plurality of rows of shelves to a target location. LunarLander is set such that a lander is landed between two flags by controlling the engine of the lander in the state in which an initial speed and direction are set randomly. CartPole is set such that the agent keeps a connected pole standing as long as possible by moving a cart along a horizontal line. Furthermore, UR5 is set such that an arm is moved to a specific position by controlling six joints that can each move along one degree of freedom. Moreover, VizDoom-Seen & Unseen is set such that the agent is placed in one corner of a square room at the start of an episode and searches for a correct object between the two objects spawned in the room. The correct object may be a target object.

Meanwhile, the agent may be trained with [symbol] at a time step t, and I(t; [symbol] ) is a stage indicator and may be defined as I(t; [symbol] ):=i (where t∈[Tᵢ₋₁, Tᵢ]). In this case, [symbol] denotes stage transition, [symbol] =(T₁, T₂, . . . , T_{N-1}), and T₀:=0 and T_{N}:=∞.

Meanwhile, as described above, the density of reward in the exploration stage and the density of reward in the goal-oriented stage may be set differently.

The controller 120 may perform reinforcement learning based on sparse to potential-based density (S2D) reward transition curriculum learning (hereinafter referred to as the “S2D curriculum”). In this case, the S2D curriculum means the curriculum [symbol] in which the density of the reward function of the MDP

$${\{ {ℳ}_{i} \}}_{i = 1}^{N}$$

gradually increases,

$${\{ {ℳ}_{i} \}}_{i = 1}^{N}$$

satisfies the conditions of Equations 1 and 2 below

$$( 𝒞 = ( {\{ {ℳ}_{1} \}}_{i = 1}^{N} , 𝒯 ) ) : supp ( {ℛ}_{1} ) ⊆ supp ( {ℛ}_{2} ) ⊆ … ⊆ supp ( {ℛ}_{N} ) \qquad ( 1 )$$

In Equation 1, supp( [symbol] ) is a region supported by a non-zero reward function [symbol] , which satisfies supp( [symbol] )={s∈S|∃α∈ [symbol] s, t, [symbol] (s, α)≈0}.

$${\prod }_{1}^{*} ⊇ {\prod }_{2}^{*} ⊇ … ⊇ {\prod }_{N}^{*} \qquad ( 2 )$$

In Equation 2, Π*ᵢ denotes a set of optimal policies having an MDP [symbol] ᵢ, where

$${\{ {ℛ}_{i} \}}_{i = 1}^{N}$$

is referred to as the guideline of a curriculum [symbol] .

Equation 1 means that as learning progresses, the density of the reward function needs to increase, i.e., the guideline needs to be clearer. Equation 2 eans that even when the learning stage, i.e., the MDP, is transitioned, the optimal policy of [symbol] ᵢ needs to be optimal in [symbol] ᵢ₊₁ as well.

### Potential-Based Density Reward Function

The controller 120 may provide a different density of reward to the agent depending on the learning stage. For example, reinforcement learning comprises an exploration stage and a goal-oriented stage. In the case of an embodiment in which reinforcement learning is performed according to the S2D curriculum, the controller 120 may provide sparse reward in the exploration stage and dense reward in the goal-oriented stage.

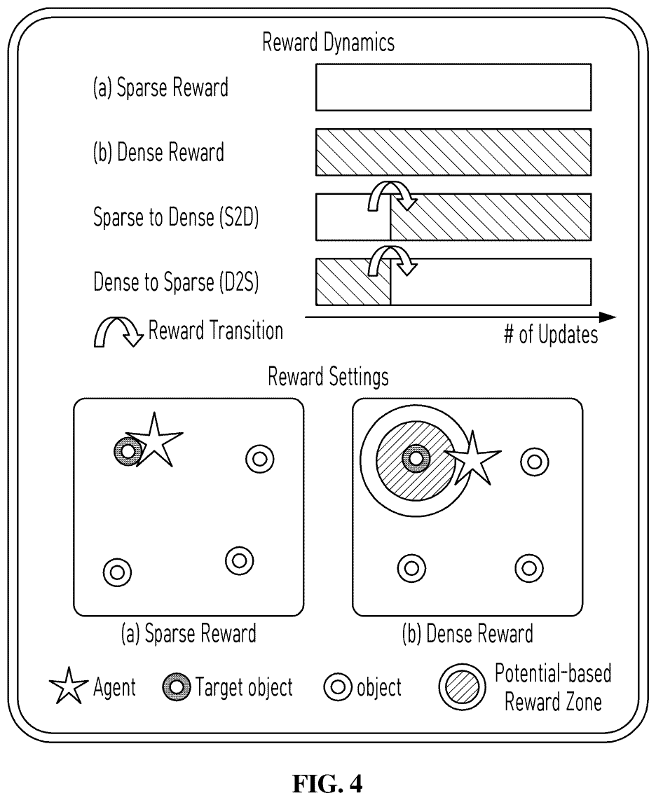

FIG. 4 is a diagram illustrating the types of reward according to an embodiment.

Referring to FIG. 4, sparse reward is the reward provided when the agent reaches a target object. When sparse reward is set, the controller 120 may provide reward to the agent when the agent successfully reaches a goal (i.e the target object) within a specific distance threshold. In contrast, dense reward provides potential-based reward together with sparse reward. In this case, additional potential-based reward may be provided depending on the degree of proximity to a goal, i.e., the distance from the goal. For example, in FIG. 4, when the agent is present in a potential-based reward zone, potential-based reward may be additionally provided. Hereinafter, the reward received when a goal has been reached is referred to as basic reward, and the potential-based reward is referred to as additional reward.

As described above, the dense reward may be represented by the sum of sparse reward, which is basic reward, and additional reward. In this case, as described in Equation 2, the definition of additional reward intended to maintain the optimality of the policy may be an important issue even when the learning stage is transitioned according to reward transition. To this end, the additional reward may be defined using potential-based reward shaping (PBRS) (Ng, A.; Harada, D.; and Russell, S. J. 1999a. Policy Invariance Under Reward Transformations: Theory and Application to Reward Shaping. In International Conference on Machine Learning, Harutyunyan, A.; Devlin, S.; Vrancx, P.; and Nowé, A. 2015. Expressing arbitrary reward functions as potential-based advice. In Proceedings of the AAAI Conference on Artificial Intelligence, volume 29). Potential-based reward shaping may define an additional reward function based on a potential function, as shown in Equation 3 below:

$${F}_{i} ( s , a ) = {𝔼}_{{s}^{′} ∼ 𝒫 ( s , a )} [ γ {Φ}_{i} ( {s}^{′} ) - {Φ}_{i} ( s ) ] \qquad ( 3 )$$

In Equation 3, Fᵢ is the additional reward, Φ is an arbitrary potential function at a stage i, and γ is a discount factor.

By utilizing the additional reward function Fᵢ, the optimality of the policy may be preserved in that the optimal policy π* for the reward function Rᵢ+Fᵢ is still optimal for Fᵢ, as shown in Equation 4 below (Harutyunyan, A.; Devlin, S.; Vrancx, P.; and Nowé, A. 2015. Expressing arbitrary reward functions as potential-based advice. In Proceedings of the AAAI Conference on Artificial Intelligence, volume 29). In other words, even when the density of the reward function changes as the learning stage is transitioned, the optimality of the policy throughout reinforcement learning may be preserved.

$$\text{} \begin{matrix}Q ( s , a ) = {𝔼}_{𝒫 , π} [ {\sum }_{t = 0}^{∞} {γ}^{t} ( {ℛ}_{i}^{t} + {F}_{i}^{t} ) \vert {s}_{0} = s ] \\ = {𝔼}_{𝒫 , π} [ {\sum }_{t = 0}^{∞} {γ}^{t} ( {ℛ}_{i}^{t} + γ {Φ}_{i} ( {s}_{t + 1} ) - {Φ}_{i} ( {s}_{t} ) ) \vert {s}_{0} = s ] \\ = {𝔼}_{𝒫 , π} [ {\sum }_{t = 0}^{∞} {γ}^{t} {ℛ}_{i}^{t} - {Φ}_{i} {s}_{0} ]\end{matrix} \qquad ( 4 )$$

In Equation 4, Q(s, α) denotes a Q function for action α (where α∈ [symbol] ) in state s (where s∈ [symbol] ). The potential function Φᵢ of Equation 4 is a random function, and, in one embodiment, may be defined as the density reward function ψ(s) of Equation 5 below:

$$ψ ( s ) = diam ( 𝒮 ) - {‖ s - g ‖}_{2} \qquad ( 5 )$$

In Equation 5, ψ(s) denotes the density reward function, s denotes the current state of the agent on the state set [symbol] (i.e., s∈ [symbol] ), g denotes the goal (where g∈ [symbol] ), [symbol] denotes the goal state (where [symbol] ⊆ [symbol] ), and diam(⋅) denotes the diameter of the state set [symbol] .

According to Equation 5, the density reward function ψ(s) is determined according to the proximity of the agent to the goal and may be calculated using a positive value based on the L2 distance between the current state s and the target g.

Table 1 below shows a reward function in an actual implementation environment. More specifically, for each environment, there are shown examples of the reward function in the case of the provision of sparse reward and the reward function in the case of the provision of dense reward. For example, in Table 1, “Sparse” means sparse reward, i.e., the reward function in the exploration stage, and “Dense” means dense reward, i.e., the reward function in the goal-oriented stage.

Referring to Table 1, the controller 120 may provide reward based on the L2 distance between the current state s of the agent and the target g in the exploration stage that provides sparse reward (Spare). More specifically, the controller 120 may provide reward when the L2 distance between the current state s of the agent and the target g is within a threshold. In contrast, in the goal-oriented stage that provides dense reward (Dense), reward may be provided based on the density reward function ψ(sₜ₊₁) of the subsequent state sₜ₊₁ and the density reward function ψ(sₜ) of the current state sₜ. More specifically, in the goal-oriented stage that provides dense reward (Dense), when the difference between the density reward function ψ(sₜ₊₁) of the subsequent state to which the discount factor γ is applied and the density reward function ψ(sₜ) of the current state is less than a threshold, the controller 120 may provide reward to the agent.

TABLE 1

| Reward | LunarLander-V2 | CartPole-Reacher | UR5 | ViZDoom-Seen | ViZDoom-Unseen |
|---|---|---|---|---|---|
| Sparse | ∥s − g∥₂ < 1 | ∥s − g∥₂ < 0.02 | ∥s − g∥₂ < 0.02 | ∥s − g∥₂ < 0.0075 | ∥s − g∥₂ < 0.0075 |

| | | | |
|---|---|---|---|
| Dense | γψ(sₜ₊₁) − ψ(sₜ) < 0.3 | γψ(sₜ₊₁) − ψ(sₜ) < 1 | γψ(sₜ₊₁) − ψ(sₜ) < 0.14 |

Meanwhile, in Table 1, LunarLander-V2 is the same as LunarLander described in FIG. 3, CartPole-Reacher is the same as CartPole described in FIG. 3, and UR5, ViZDoom-Seen, and ViZDoom-Unseen are also similar to ViZDoom-Seen & Unseen described in FIG. 3. However, in ViZDoom-Seen, the locations of objects are random and walls may have one of three textures. In contrast, ViZDoom-Unseen may have three new wall textures compared to ViZDoom-Seen.

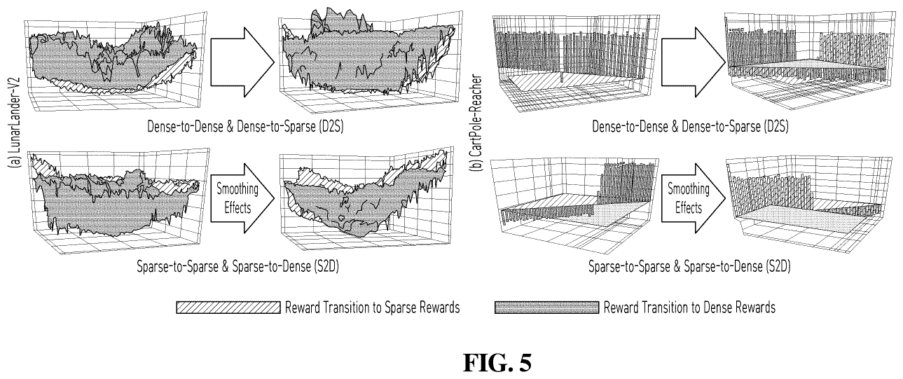

FIG. 5 is a diagram illustrating the performance of a reinforcement learning method according to an embodiment. More specifically, FIG. 5(a) shows the policy loss landscape in LunarLander-V2 described with reference to FIG. 3, and FIG. 5(b) shows the policy loss landscape in CartPol-Reacher described with reference to FIG. 3. The dotted areas of FIG. 5 indicate that reward transition of Spare-to-Dense or Dense-to-Dense, whereas the hashed areas of FIG. 5 indicate that reward transition of Spare-to-Spare or Dense-to-Spare.

Dense-to-Dense (dotted area on the upper left side) denotes a reinforcement learning method that provides only dense reward, and Sparse-to-Sparse (hashed area on the upper left side) denotes a reinforcement learning method that provides only sparse reward. Spare-to-Dense (S2D; dotted area on the lower left side) denotes a reinforcement learning method according to an embodiment that gradually increases the density of reward from sparse reward to dense reward. Conversely, Dense-to-Spare (D2S, hashed area on the upper left side) denotes a reinforcement learning method that decreases the density of reward from dense reward to sparse reward.

Referring to FIG. 5(a), it can be seen that Spare-to-Dense (S2D; dotted area on the lower left side), which is a reinforcement learning method according to an embodiment, prominently exhibits the smoothing effect in which the loss height is lowered compared to Dense-to-Dense (dotted area on the upper left side), Dense-to-Sparse (D2S; hashed area on the upper left side), and Sparse-to-Sparse (hashed area on the lower left side).

In FIG. 5(b), it can also be seen that Spare-to-Dense (S2D; dotted area on the lower left side), which is a reinforcement learning method according to an embodiment, prominently exhibits the smoothing effect in which the loss height is lowered compared to Dense-to-Dense (dotted area on the upper left side), Dense-to-Sparse (D2S; hashed area on the upper left side), and Sparse-to-Sparse (hashed area on the lower left side).

As described above, the reinforcement learning apparatus 100 according to an embodiment transitions the reward from sparse reward to dense reward having a high reward density at a predetermined point, so that there occurs the smoothing effect that makes the loss slope smooth. Accordingly, the generalization performance of the agent may be improved by having wide minima rather than local minima, thereby increasing adaptability to problems in various fields. Furthermore, in the exploration stage that provides sparse reward, the agent is allowed to acquire knowledge in various fields, thereby preventing the overfitting problem that may occur in goal-oriented reinforcement learning that only provides dense reward.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

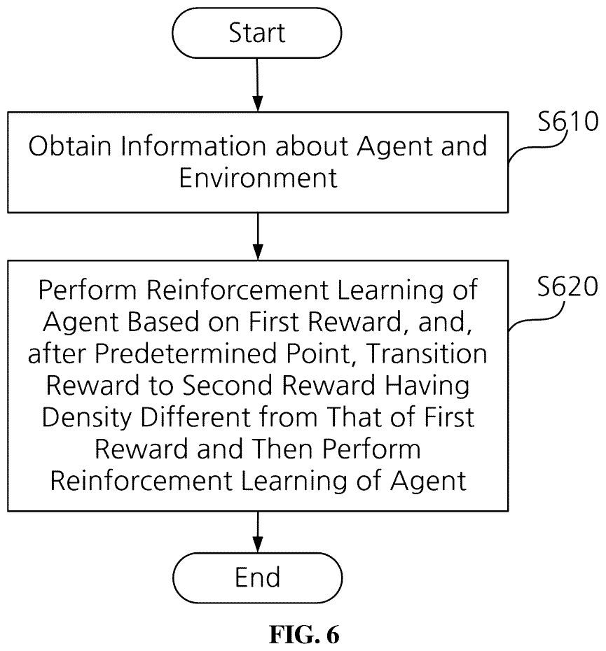

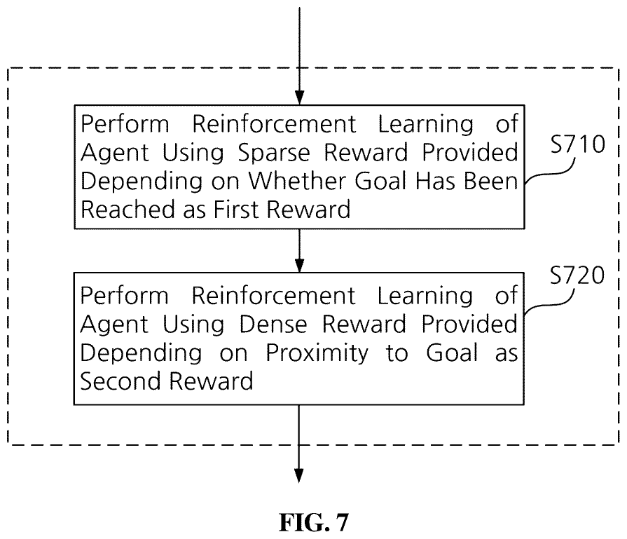

Meanwhile, FIGS. 6 and 7 are flowcharts illustrating a reinforcement learning method according to an embodiment. The reinforcement learning method shown in FIGS. 6 and 7 includes steps that are processed in a time-series manner by the reinforcement learning apparatus 100 shown in FIGS. 1 to 5. Accordingly, the descriptions that are omitted below but have been given above in conjunction with the reinforcement learning apparatus 100 shown in FIGS. 1 to 5 may also be applied to the reinforcement learning method shown in FIGS. 6 and 7.

FIG. 6 is a flowchart illustrating a reinforcement learning method according to an embodiment, and FIG. 7 is a flowchart illustrating step S620 of FIG. 6 in detail.

Referring to FIG. 6, the reinforcement learning apparatus 100 may obtain information about an agent and an environment in step S610. More specifically, the reinforcement learning apparatus 100 may obtain the state set, action set, and reward function of an agent for the performance of reinforcement learning, a curriculum comprising two or more learning stages, i.e., a plurality of learning stages, and a reward transition point at which the learning transitions from a first learning stage providing first reward to a second learning stage providing second reward. In this case, the reward transition point may be a hyperparameter input from a user.

Next, the reinforcement learning apparatus 100 may perform the reinforcement learning of the agent based on the first reward and may transition the reward to the second reward that is different from the first reward after a predetermined point and provide reinforcement learning based on the second reward. For example, the first reward may be one of sparse reward provided depending on whether a goal has been reached and dense reward provided depending on the proximity to the goal. When the first reward is sparse reward, the second reward may be dense reward. Conversely, when the first reward is dense reward, the second reward may be sparse reward.

Referring to FIG. 7, the reinforcement learning apparatus 100 may perform reinforcement learning using sparse reward as the first reward and dense reward as the second reward.

More specifically, the reinforcement learning apparatus 100 may perform reinforcement learning based on sparse reward in step S710. For example, the reinforcement learning apparatus 100 may calculate the L2 distance between the current state of the agent and the goal, and, when the calculated distance is shorter than a preset threshold, may determine that the agent has reached the goal and provide reward.

Meanwhile, after a predetermined point, the reinforcement learning apparatus 100 may transition from the sparse reward to dense reward and perform reinforcement learning based on the dense reward in step S720. For example, the reinforcement learning apparatus 100 may provide reward depending on whether the goal has been reached, as in the case of the sparse reward, and additionally provide reward depending on the proximity to the goal. The reward based on the proximity to the goal may be calculated using a potential-based density reward function.

As described above, the reinforcement learning method according to an embodiment transitions the reward from sparse reward to dense reward having a high reward density at a predetermined point and then performs learning, thereby improving the generalization performance of the agent. Furthermore, in the exploration stage that provides sparse reward, the agent is allowed to acquire knowledge in various fields, thereby preventing the overfitting problem that may occur in goal-oriented reinforcement learning that only provides dense reward.

The reinforcement learning method according to the embodiment described with reference to FIGS. 6 and 7 may be implemented in the form of a computer-readable medium that stores instructions and data that can be executed by a computer. In this case, the instructions and the data may be stored in the form of program code and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium.

The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the reinforcement learning method according to the embodiment described with reference to FIGS. 6 and 7 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the reinforcement learning method according to the embodiment described with reference to FIGS. 6 and 7 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

According to some of the above-described solutions, the reward is transitioned from sparse reward to dense reward having a high reward density at a predetermined point and then learning is performed, so that there occurs a smoothing effect that makes the loss slope smooth, with the result that the generalization performance of an agent can be improved by having wide minima rather than local minima, thereby increasing adaptability to problems in various fields.

According to some of the above-described solutions, in the exploration stage that provides sparse reward, the agent is allowed to acquire knowledge in various fields, thereby preventing the overfitting problem that may occur in goal-oriented reinforcement learning that only provides dense reward.

The advantages that can be achieved by the embodiments disclosed herein are not limited to the advantages described above, and other advantages not described above will be clearly understood by those having ordinary skill in the art, to which the embodiments disclosed herein pertain, from the foregoing description.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A reinforcement learning method, the reinforcement learning method being performed by a reinforcement learning apparatus, the reinforcement learning method comprising:
obtaining information about an agent which is trained by reinforcement learning; and
performing reinforcement learning of the agent based on first reward, and, after a predetermined point, transitioning reward to second reward having a density different from that of the first reward and then performing reinforcement learning of the agent.

2. The reinforcement learning method of claim 1, wherein one of the first reward and the second reward is sparse reward provided depending on whether the agent has reached the goal, and remaining reward is dense reward provided depending on whether the agent has reached the goal and proximity to the goal.

3. The reinforcement learning method of claim 2, wherein performing the reinforcement learning of the agent comprises performing reinforcement learning using the sparse reward as the first reward, and, at a predetermined point, transitioning from the dense reward to the second reward and then performing reinforcement learning.

4. The reinforcement learning method of claim 2, wherein performing the reinforcement learning of the agent comprises determining the dense reward using a density reward function calculated based on an L2 distance between a current state of the agent and the goal.

5. A reinforcement learning apparatus, comprising:
memory configured to store programs required for generation of an agent and reinforcement learning; and
a controller configured to obtain information about the agent which is trained by reinforcement learning, and to perform reinforcement learning of the agent based on first reward, and, after a predetermined point, transitioning reward to second reward having a density different from that of the first reward and then performing reinforcement learning of the agent.

6. The reinforcement learning apparatus of claim 5, wherein the controller determines any one of sparse reward provided depending on whether the agent has reached a goal and dense reward provided depending on whether the agent has reached the goal and proximity to the goal to be the first reward and then performs reinforcement learning, and, after a predetermined point, determines remaining reward to be the second reward and then performs reinforcement learning.

7. The reinforcement learning apparatus of claim 6, wherein the controller performs reinforcement learning of the agent using the sparse reward as the first reward, and, at a predetermined point, transitions reward from the dense reward to the second reward and then performs reinforcement learning.

8. The reinforcement learning apparatus of claim 6, wherein the controller calculates the dense reward using a density reward function calculated based on an L2 distance between a current state of the agent and the goal.

9. A computer program that is executed by a reinforcement learning apparatus and stored in a non-transitory computer-readable storage medium to perform the method set forth in claim 1.

10. A non-transitory computer-readable storage medium having stored thereon a program that, when executed by a processor, causes the processor to execute the method set forth in claim 1.
